(19) United States
(12) Patent Application Publication
(10) Pub. No.: US 2024/0351150 A1
(43) Pub. Date: Oct. 24, 2024

(54) HOLDING DEVICE COMPRISING VACUUM MODULES AND BRUSHES FOR HOLDING A SHEET MATERIAL AND MODULAR SYSTEM

(71) Applicant: SCHUNK Electronic Solutions GmbH, St. Georgen (DE)

(72) Inventors: Sven Flaig, Niedereschach (DE); Mattias Kiebe, Tuttlingen (DE); Stefan Ringwald, Elzach (DE)

(21) Appl. No.: 18/640,449

(22) Filed: Apr. 19, 2024

(30) Foreign Application Priority Data
Apr. 21, 2023 (DE) 10 2023 110 268.0

(51) Int. Cl. B23K 37/04; B23K 26/38; B23Q 3/08

(52) U.S. Cl. CPC B23K 37/0408; B23K 37/0435; B23Q 3/088; B23K 26/38

(57) ABSTRACT

A holding device (200) for holding a sheet material (12) in a machining device (10), in particular a laser machining device, includes a working plate (204), vacuum devices (206), and support modules (208). The working plate (204) has a plate upper side (220) extending along a plate plane (222). The vacuum devices (206) extend along a holding direction (271), each having a base (226) arranged on the plate upper side (220) and a nozzle head (256) arranged on the base (226) for suctioning the sheet material (12). The support modules (208) extend along the holding direction (271), each having a module base (288) arranged on the plate upper side (220) and a brush (302) arranged on the module base (288) and extending along a brush plane (301) for supporting the sheet material (12).

### BACKGROUND

This disclosure relates to a holding device for holding a sheet material and an associated modular system.

### SUMMARY

Sheet materials, in particular anode and cathode foils, are required in the electronics industry and, in particular, in the production of battery packs for E-mobility.

For the purposes of this application, sheet materials are to be understood as single- or multi-layer films or foils, wherein the films or foils have a substantially greater longitudinal and transverse dimension than a thickness. Furthermore, the sheet material is designed to be flexible, so that the sheet material does not deviate substantially from a flat shape across the longitudinal and transverse dimension. Furthermore, the sheet material is at least substantially gas-impermeable, so that the sheet material can be suctioned. Furthermore, the sheet material or its layers is in each case monolithic. The sheet materials may, in particular, comprise plastic or metal, wherein metal-coated plastics or plastic-coated metals are also conceivable. The sheet material may be designed as a sheet material strip section. The sheet material may be, for example, a current collector foil having dimensions of 200 mm×280 mm, wherein the foil comprises graphite and is coated with aluminum or copper.

The sheet material represents a semi-finished product from which at least one cut piece is produced. The cut pieces have the outer contour required for the application and are designed smaller than the sheet material with respect to the longitudinal and transverse dimension. The remaining part of the sheet material that is not associated with the cut pieces is referred to as waste.

The handling, fixing and machining of such sheet materials, in particular, the production of cut pieces from the sheet material by means of laser machining, is complex due to the thin and flexible design of the sheet material and further due to the destructive properties of the laser beam.

Accordingly, the present disclosure is based on the object of providing a holding device for holding a sheet material in a machining device, in particular, a laser machining device, wherein the holding device is designed to be simple to establish and durable.

The object on with the disclosure is based, is achieved by a holding device having the features of claim 1. The holding device has a working plate with a plate upper side extending along a plate plane. The holding device further has vacuum devices extending along a holding direction, each having a base arranged on the plate upper side and a nozzle head arranged on the base for suctioning the sheet material. In addition, the holding device has support modules extending along the holding direction, each having a module base arranged on the plate upper side and a brush arranged on the module base and extending along a brush plane for supporting the sheet material. For secure holding of the sheet material, it is necessary for the sheet material to be supported at regular intervals, in particular at the edges of the sheet material, so that the sheet material does not deviate from the flat design. Because in the flat design, the sheet material can be securely gripped, tensioned, and machined. If the sheet material is machined while it rests on a holding device, then there is a conflict between the movement path of the machining tool or machining medium, in particular a saw blade or a laser beam, and the element supporting the sheet material. For secure holding, it is expedient to provide as many vacuum devices as possible. For high flexibility in the movement path, it is expedient to provide as few vacuum devices as possible. If contact between the machining tool and the vacuum device occurs, the vacuum device is destroyed and replacement of the vacuum device is necessary. Furthermore, the holding capacity is reduced by destroying the vacuum device.

It is therefore advantageous that, in addition to the vacuum devices, support modules with brushes are also provided. Providing support modules does not limit the flexibility of the movement path, since the brush is not instantly destroyed when it comes into contact with the machining tool and does not need to be replaced immediately. The brush is designed as a wear part and maintains the holding effect despite contact. It is advantageous if the vacuum devices are arranged such that they are arranged at positions of the sheet material to be supported, along which positions the movement path does not run, and if the support modules are arranged such that they are arranged at positions of the sheet material to be supported along which the movement path runs. Furthermore, it is advantageous for at least one vacuum device to be arranged in the region of the cut piece and at least one vacuum device in the region of the waste. Once the brush has repeatedly contacted the machining tool or the machining medium, the brush can be replaced easily, quickly and inexpensively. The holding device is thus also suitable for secure use, for example with a saw blade or a laser beam for cutting the sheet material. In addition, it is ensured that, even after the cutting of the sheet material into at least one cut piece and the waste, the cut piece and the waste are held securely.

The vacuum devices and/or the support modules are advantageously arranged such that the holding direction runs perpendicular to the plate plane. In this case, the sheet material, which extends along a material plane, can be deposited perpendicularly onto the holding device. In the machining state, the sheet material is preferably arranged between the holding device and the machining device, in particular the laser device.

The working plate preferably has a ferromagnetic material, in particular a ferrous material. For easy fixing and individual arrangement of the vacuum devices on the working plate, the vacuum devices each have a permanent magnet arranged in the base, which interacts with the ferromagnetic material of the working plate during fixing. For easy fixing and individual arrangement of the support modules on the working plate, the support modules each have a permanent magnet arranged in the module base, which interacts with the ferromagnetic material of the working plate during fixing. For receiving the permanent magnets, the base and/or the module base have a magnet receptacle on a base underside which is directed toward the working plate. The base underside can be designed to be open or closed.

An advantageous development of the disclosure provides that the vacuum device has an adapter piece arranged between the base and the nozzle head. The adapter piece has a nozzle interface for arranging the nozzle head and enables the arrangement of differently dimensioned nozzle heads on the base. Thus, with an unvarying base, unvarying positioning and connection to a vacuum supply, nozzle heads of different sizes can be realized, so that a suction force acting on the sheet material can be individually adapted. Furthermore, the modular design of the adapter pieces and the nozzle heads enables rapid and easy exchange.

It is advantageous if a conduit running along the holding direction is provided in the vacuum device. The conduit fluidically connects a conduit input arranged on the base for connection to a vacuum supply and a conduit output arranged on the nozzle head. Thus, with the nozzle head at the conduit outlet, a vacuum can be created on the sheet material, which vacuum sucks the sheet material against the vacuum device. In the base and/or in the adapter piece and/or in the nozzle head, a cavity is provided, respectively, which cavity forms the continuous conduit in the assembled state. The base preferably has a conduit port to which a conduit can be coupled which is fluidically connected to a vacuum supply. It is conceivable that the conduit inlet runs perpendicular to the holding direction and opens into the cavity extending parallel to the holding direction.

It is further advantageous if the support modules are arranged on the working plate such that the brush plane runs perpendicular to the plate plane. Consequently, the gravitational force of the sheet material can be directed through the brush or the support module into the working plate.

Preferably, the support modules each have a module bar between the module base and the brush. Different brushes can be arranged on the module bar. Furthermore, the modular design of the module bars and the brushes enables rapid and easy replacement.

It is advantageous if the support modules each have a brush receptacle for receiving the brush. The brush receptacle is preferably rail-shaped and has a groove running parallel to the brush plane, wherein the brush is partially accommodated in the groove. The brush receptacle is preferably connected to the module bar with a fastening means, in particular a screw, running parallel to the plate plane. A thread which can interact with the fastening means is preferably provided in the module bar.

It is further advantageous if a clamping element is provided for fixing the brush in the brush receptacle. The clamping element and the brush may be designed as one part or monolithically. The clamping element can be inserted laterally, perpendicular to the holding direction into the brush receptacle. If the brush and the clamping element are designed to be detachable from one another, the brush can be inserted into the brush receptacle first and then the clamping element.

An advantageous development provides that the brush has a plurality of bristles. Thus, when the machining tool or machining medium contacts the brush, only individual bristles are destroyed, wherein the remaining bristles continue to maintain the holding function of the brush.

The description further comprises a holding device according to claims 1 to 9, wherein a brush comprises a plurality of bristles.

A further advantageous development provides that the brush, in particular the bristles, are made of a plastic, in particular nylon or polypropylene. Furthermore, it is advantageous if the bristles have a diameter in the range between 1 μm to 500 μm, in particular between 2 μm and 200 μm, preferably between 5 μm and 100 μm, and preferably between 20 μm and 60 μm.

The description further comprises a holding device according to claims 1 to 9, wherein the brush, in particular the bristles, are made of a plastic.

An advantageous development provides that the holding device has a protective plate extending parallel to the plate plane. The protective plate serves to protect the holding device from the machining tool and/or the machining medium. It can thus be ensured that the holding device, in particular its components, wear less and are durable. When a laser beam is used, the protective plate can be optically designed such that the laser radiation is at least partially absorbed. The protective plate is preferably arranged between the sheet material or the upper side of the holding device and the working plate. The protective plate is preferably arranged between the base and the adapter piece or between the adapter piece and the nozzle head. The protective plate is preferably arranged between the module base and the module bar or between the module bar and the brush receptacle.

Another advantageous development provides that the protective plate is designed as a grid plate. The grid plate has grid recesses with which the vacuum devices and/or the support modules can engage. Preferably, the grid recesses are used for positioning the vacuum devices and/or the support modules on the working plate. The grid plate can serve as an additional fixing for the vacuum devices and/or the support modules along the plate plane.

It is advantageous if the base and the module base are of identical design. The position of the vacuum device and the support modules can thus be interchanged as desired, and more identical parts are used. If a support module is used on a base with a conduit port, the conduit port can be closed with a detachable blind plug.

An advantageous development of the disclosure provides that the holding device additionally has a base plate, wherein the working plate is arranged on, at or in the base plate. The base plate may be designed to be solid. Furthermore, the base plate may have bores for connection to a base housing of a machining device.

A further advantageous embodiment of the disclosure provides that at least one tube clamp is provided for fixing tubes on the working plate and/or on the base plate. The tubes can thus be securely fastened to the holding device. By means of the tubes, the vacuum supply can be fluidically connected to each of the conduit port of the base, and the vacuum device can be supplied with a vacuum. The tube clamps may preferably be arranged along the plate plane next to the protective plate on the working plate, in particular, if the working region of the machining tool or machining medium is provided only in the region of the protective plate.

The description further comprises a holding device according to claims 1 to 11, wherein at least on tube clamp for fixing tubes is provided, wherein a vacuum supply can be fluidically connected to a respective conduit input by means of the tubes.

It is advantageous if the tube clamp has a clamping base with a permanent magnet for fixing the tube clamp on the working plate. The tube clamps can thus also be positioned and easily and quickly fixed on the working plate.

The underlying object of the disclosure is further solved by a modular system having the features of claim 14. The modular system has at least a plurality of vacuum devices, in particular, bases and/or adapter pieces and/or nozzle heads, in different sizes and at least one support module. Advantageously, the modular system further has support modules, in particular, module bases and/or module bars and/or brush receptacles and/or a brush and/or bristles, in different sizes. Advantageously, the modular system further has at least one ferromagnetic working plate and/or a base plate. Advantageously, the modular system further has tube clamps, in particular in different sizes. Additionally or alternatively to the size, the elements contained in the modular system can also differ with respect to shape and/or material.

The object of the disclosure is also achieved by a machining device having a holding device as described above.

Further details and advantageous embodiments of the disclosure can be found in the following description, by which embodiments of the disclosure are further described and explained.

### BRIEF DESCRIPTION OF THE DRAWINGS

FIG. 1 is a perspective view of a holding device according to the disclosure;

FIG. 1a is a schematic side view of a further holding device according to the disclosure;

FIG. 2 is a perspective view of a further holding device according to the disclosure;

FIG. 3 is a further perspective view of the holding device according to FIG. 2;

FIG. 4 is a perspective view of a base plate according to the disclosure with a workpiece;

FIG. 5 is a perspective view of a vacuum device according to the disclosure;

FIG. 6 is a further perspective view of the vacuum device according to FIG. 5;

FIG. 7 is a schematic sectional view of the vacuum device according to FIG. 5;

FIG. 8 is a perspective view of a support module according to the disclosure;

FIG. 9 is a schematic sectional view of the support module according to FIG. 8;

FIG. 10 is a perspective view of a tube clamp according to the disclosure;

FIG. 11 is a schematic sectional view of the tube clamp according to FIG. 10;

FIG. 12 shows a machining device with a holding device according to the disclosure; and

FIG. 13 shows a magazine of the machining device according to FIG. 12 with a holding device according to the disclosure.

### DETAILED DESCRIPTION

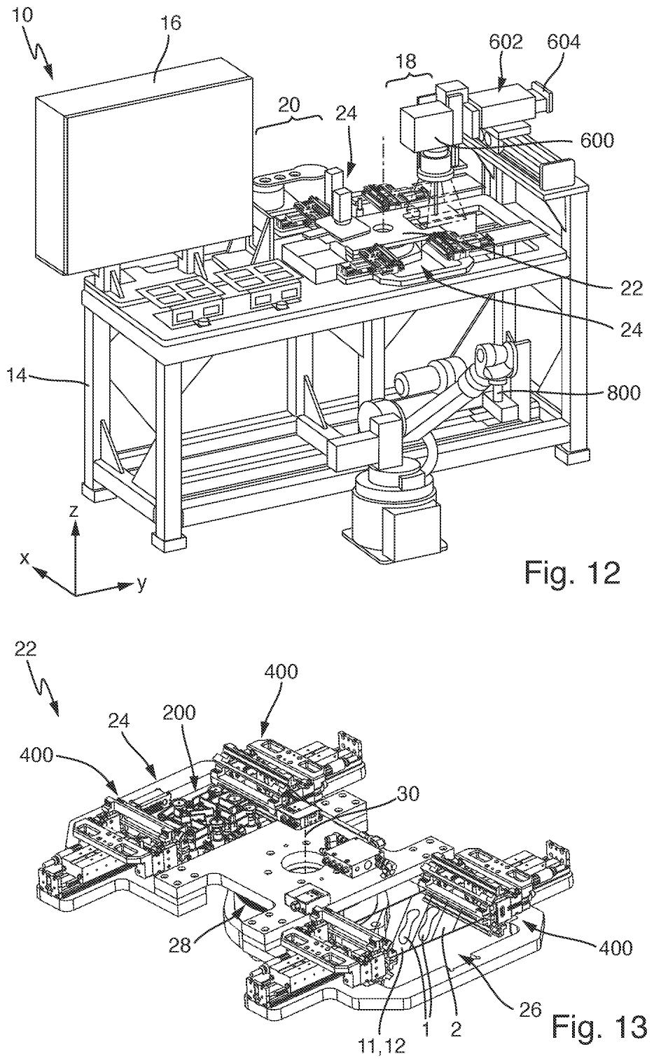

The machining device 10 shown in FIG. 12 serves to machine sheet materials 12 which extend along a material plane 11 and are in particular flexible and substantially gas-impermeable. Such sheet materials 12 are, for example, paper or foils. The sheet materials 12 may be of single-layer and multi-layer design, wherein the base material and/or the coating material may be made of plastic or metal. In particular for battery production, foils having a base material based on graphite and having a coating material based on copper or aluminum are to be produced. Due to the small thickness and the flexible properties of the sheet material 12, special requirements are placed on the machining device 10.

According to FIG. 12, the machining device 10 has a device housing 14 and a switch cabinet 16. In the device housing 14, the machining device 10 has a machining region 18 and a loading region 20. Furthermore, the machining device 10 has an x-axis X, a y-axis Y running perpendicular to the x-axis X and a z-axis Z running perpendicular to the x- and y-axis. In the loaded state, the material plane 11 of the sheet material 12 runs parallel to the x-axis and the y-axis and perpendicular to the z-axis.

According to FIG. 13, the machining device 10 has a magazine 22 with a first magazine space 24 and a second magazine space 26. The magazine 22 is rotatable about a magazine axis 30 running parallel to the z-axis by means of a rotary drive 28, so that one magazine space 24, 26 can be pivoted into the machining region 18 in a machining position and the other magazine space 24, 26 can be pivoted into a loading position into the loading region 20, respectively. The machining position and the loading position are arranged opposite one another along the y-axis. Furthermore, the magazine 22 can be rotated such that both the first magazine space 24 and the second magazine space 26 can be pivoted in an intermediate position outside of the machining region 18 and outside of the loading region 20.

Each magazine space 24, 26 has a vacuum holding device 200 and a jaw-shaped clamping device 400. Accordingly, the holding device 200 and the clamping device 400 are pivoted with the associated magazine space 24, 26 into the machining position, the loading position or the intermediate position.

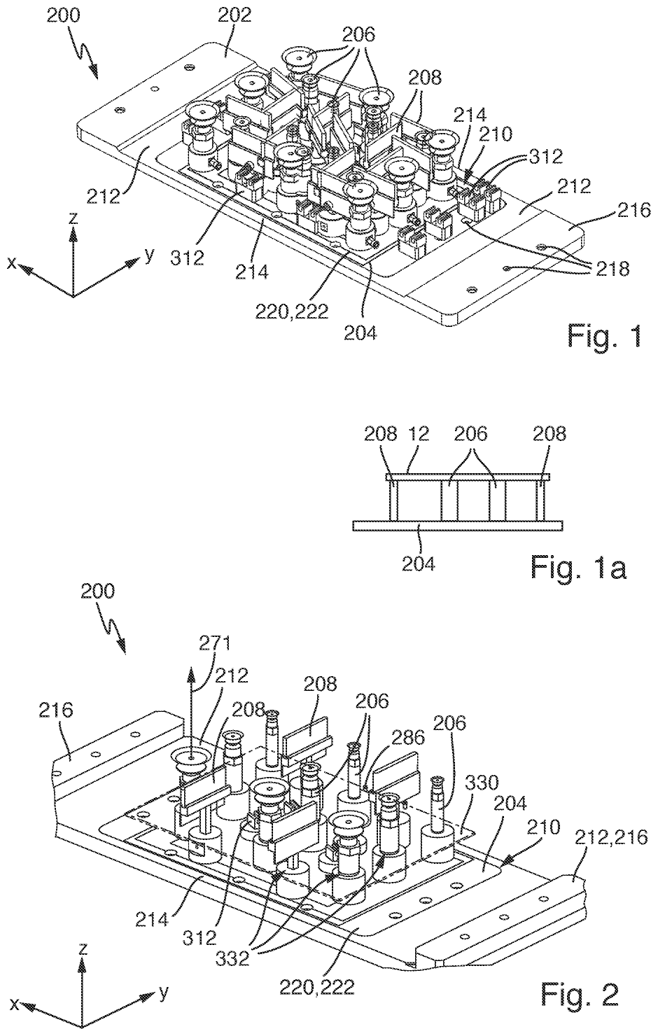

According to FIGS. 1 to 3, the holding device 200 has a base plate 202 and a working plate 204 arranged in the base plate 202. The working plate 204 comprises a ferromagnetic material, preferably iron. The base plate 202 and/or the working plate 204 preferably have the outer dimensions of the sheet material 12 to be machined along the x-axis and the y-axis. In FIG. 1 16 and in FIG. 2 nine magnetic vacuum devices 206 extending along a holding direction 271, parallel to the z-axis, are provided on the working plate 204, wherein the vacuum devices 206 are designed in three different sizes, respectively. Furthermore, in FIG. 1 16 and FIG. 2 four magnetic support modules 208 extending along the holding direction 271 are formed. The vacuum devices 206 are arranged on the working plate 204 such that they do not collide with the movement path of the laser beam. The support modules 208 are arranged such that they additionally support the sheet material 12 and may be arranged in the movement path of the laser beam.

According to FIG. 4, the base plate 202 has a plate receptacle 210 for receiving the working plate 204. The plate receptacle 210 is designed such that the working plate 204 is accommodated flush in the base plate 202. By separating the base plate 202 and the working plate 204, the working plate 204 can be replaced easily and quickly in the event of wear. The base plate 202 has side regions 212 projecting parallel to the x-axis of the working plate 204 and narrow regions 214 projecting parallel to the y-axis of the working plate 204. A plate shoulder 216 is provided on each of the side regions 212. The plate shoulder 216 is designed to be thicker relative to the rest of the base plate 202, so that a secure fastening of the holding device 200 is possible. Preferably, in the region of the plate receptacle 210, the side regions 212 and the plate shoulders, bores 218 are provided for fastening peripherals, such as tube clamps 312, or for fastening to a housing or magazine 22.

The working plate 204 has a plate upper side 220 extending along a plate plane 222. The vacuum devices 206 and the support modules 208 can be positioned and fixed on the plate upper side 220. Both the vacuum devices 206 and the support modules 208 have permanent magnets 224 which interact with the ferromagnetic material of the working plate 204.

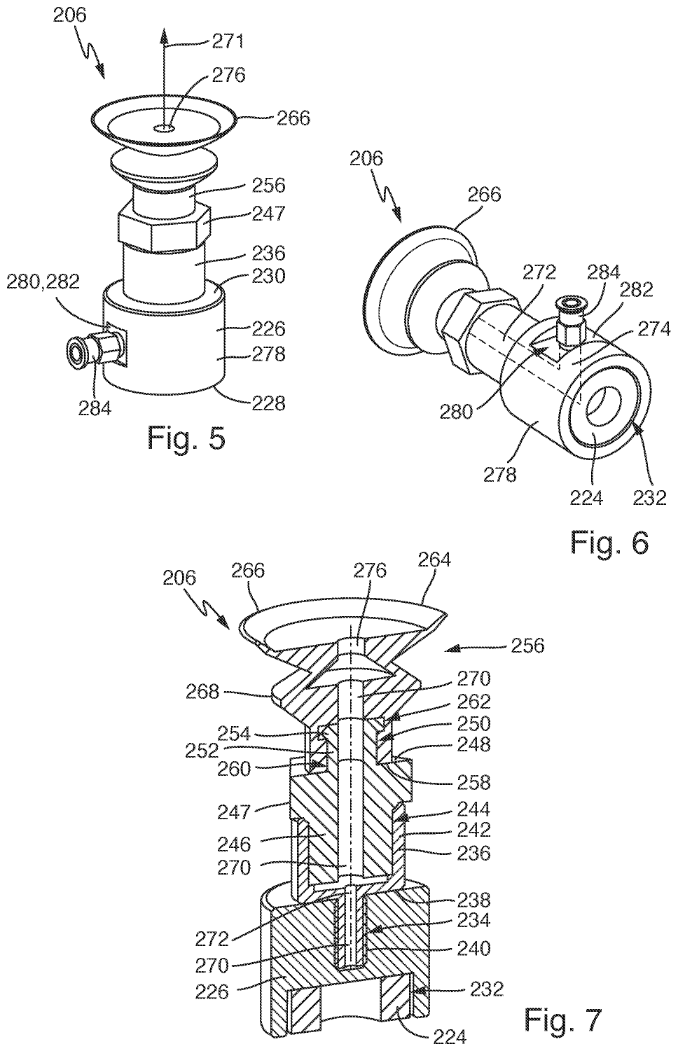

According to FIGS. 5 to 7, the vacuum devices 206 have a circular-cylindrical base 226 with a base underside 228 and a base upper side 230. A magnet receptacle 232 for receiving the, in particular, hollow-cylindrical permanent magnet 224 is provided on the base underside 228. An adapter receptacle 234 for releasably receiving an adapter piece 236 is provided on the base upper side 230. The adapter receptacle 234 is preferably designed to be circular-cylindrical and extends parallel to the z-axis.

On an adapter underside 238, the adapter piece 236 has a hollow circular-cylindrical first adapter shaft 240, which can be inserted and/or screwed into the adapter receptacle 234. The adapter piece 236 further has a hollow circular-cylindrical adapter cylinder 242 which adjoins the adapter shaft 240 and is designed as an intermediate receptacle 244.

A hollow circular-cylindrical connection piece 246 is received and/or screwed into the intermediate receptacle 244. For tightening, the connection piece 246 preferably has an external hexagon profile 247. The adapter piece 236 has a nozzle interface 250 on an adapter upper side 248, in particular on the connection piece 246. The nozzle interface 250 has an interface shaft 252 and an interface cone 254 adjoining the interface shaft 252. The adapter piece 236 is preferably of two-part construction, wherein the adapter shaft 240 and the adapter cylinder 242 are designed as one part and the connection piece 246 is designed as one part with the interface shaft 252 and the interface cone 254. It is further conceivable for the adapter piece 236 to be formed as one part.

A nozzle head 256 can be arranged at the nozzle interface 250, wherein the nozzle head 256 has a nozzle recess 260 with a nozzle undercut 262 on a nozzle underside 258, wherein the interface cone 254 engages behind the nozzle undercut 262 when the nozzle head 256 is placed onto the nozzle interface 250 and thereby fixes the nozzle head 256 on the nozzle interface 250. A pan-shaped gripping portion 266 for contacting, sucking in and gripping the sheet material 12 is provided at a nozzle upper side 264 of the nozzle head 256. A double conical plate portion 268 is provided between the nozzle recess 260 and the gripping portion 266, which plate portion enables an elastic deformation of the nozzle head 256 along the z-axis and thus contributes to the smooth gripping of the sheet material 12.

A cavity 270 is provided in the interior of the vacuum devices 206, in particular in the base 226, in the adapter piece 236, in the connection piece 246 and/or in the nozzle head 256, respectively, which cavity forms a continuous conduit 272 running along the z-axis in the assembled state. The conduit 272 fluidically connects a conduit input 274 arranged on the base 226 and extending parallel to the plate plane 222 with a conduit output 276 arranged on the gripping portion 266.

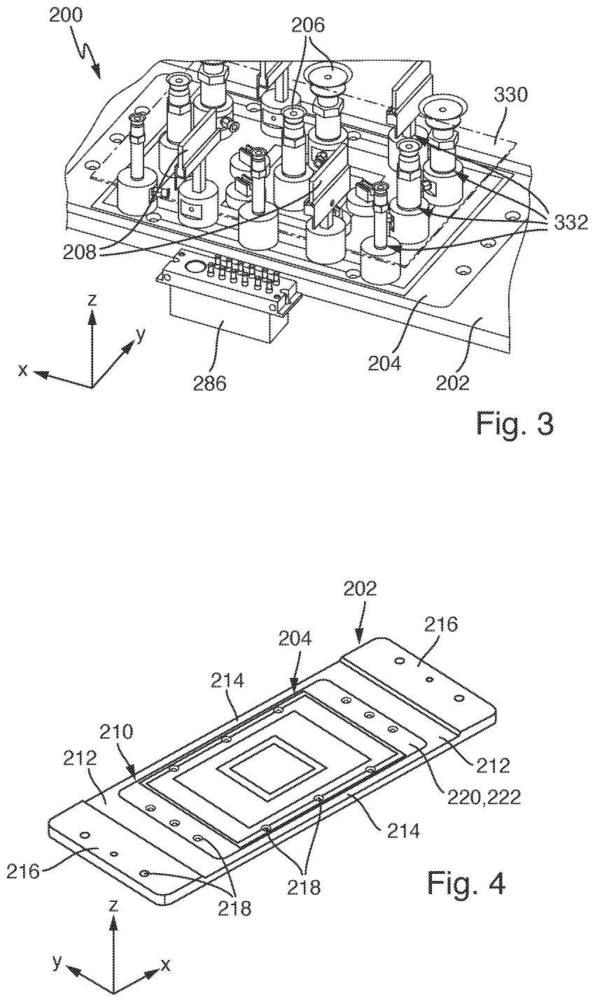

The base 226 has a base recess 280 with a flat recess bottom 282 on its base outer surface 278, wherein the conduit inlet 274 opens into the recess bottom 282. A conduit port 284 can be connected to the base recess 280, which conduit port fluidically connects the vacuum device 206 to a vacuum supply (not shown) by means of tubes (not shown). For distributing the medium from the vacuum supply to the tubes, a pressure distribution 286 shown in FIG. 3 can be arranged on the holding device 200.

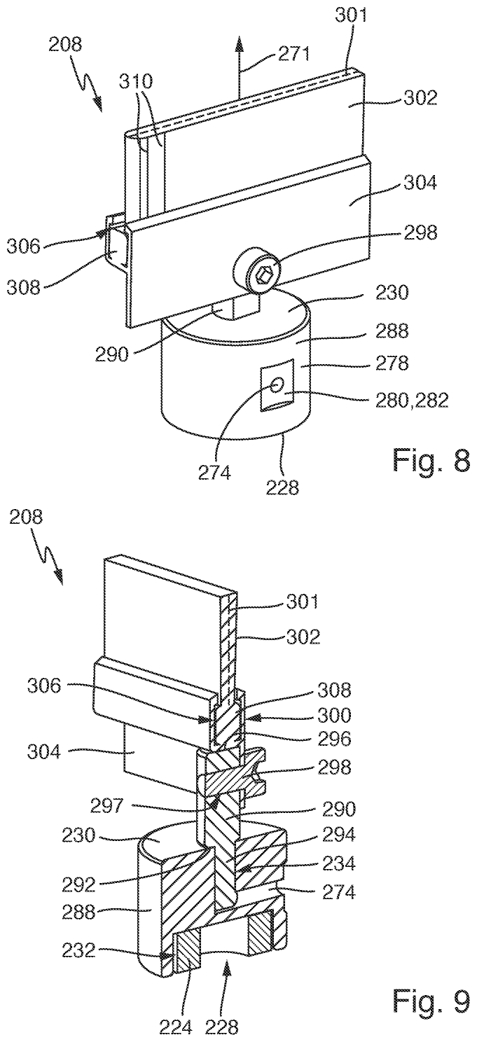

According to FIGS. 8 and 9, the support modules 208 have a module base 288. The module base 288 is preferably designed identically to the base 226, wherein the conduit input 274 can here be closed with a blind plug (not shown). Accordingly, the module base 288 also has, inter alia, a magnet receptacle 232 for receiving the, in particular, hollow-cylindrical permanent magnet 224 and an adapter receptacle 234.

However, a circular-cylindrical module bar 290 is releasably arranged in the adapter receptacle 234 of the module base 288. On its bar underside 292, the module bar 290 has a bar shaft 294 which can be inserted and/or screwed into the adapter receptacle 234. A fastening receptacle 296 running parallel to the plate plane 222 is provided on the bar upper side 296 of the module bar 290.

A brush receptacle 300 for receiving a brush 302 extending along a brush plane 301 can be fastened to the module bar 290 by means of a fastening means 298. The brush receptacle 300 has a connection portion 304 running perpendicular to the plate plane 222, wherein the fastening means 298 can be inserted centrally through the connection portion 304, and the connection portion 304 comes to bear laterally against the module bar 290 in the mounted state. Adjoining the connection portion 304, the brush receptacle 300 has a groove portion 306 running parallel to the plate plane 222, which groove portion rests on the module bar 290, in particular in the mounted state. The brush 302 can be inserted into the groove portion 306.

For this purpose, the brush 302 has a clamping element 308, wherein the clamping element 308 can be inserted laterally into the groove portion 306. The brush 302 further has a plurality of bristles 310 running parallel to the z-axis. The brush 302 serves to hold the sheet material 12 provided on the holding device 200, wherein the holding capability of the support modules 208 is maintained even if a small number of bristles 310 are worn, e.g., due to contact with a laser beam.

The module base 288, the module bar 290, the brush receptacle 300 and the brush 302 may be formed as multiple parts. However, it is conceivable that the brush receptacle 300 and the brush 302 are designed as one part. It is further conceivable that the bristles 310 and the clamping element 308 are designed as one part or multiple parts. It is further conceivable that the brush receptacle 300 and the module bar 290 are designed as one part.

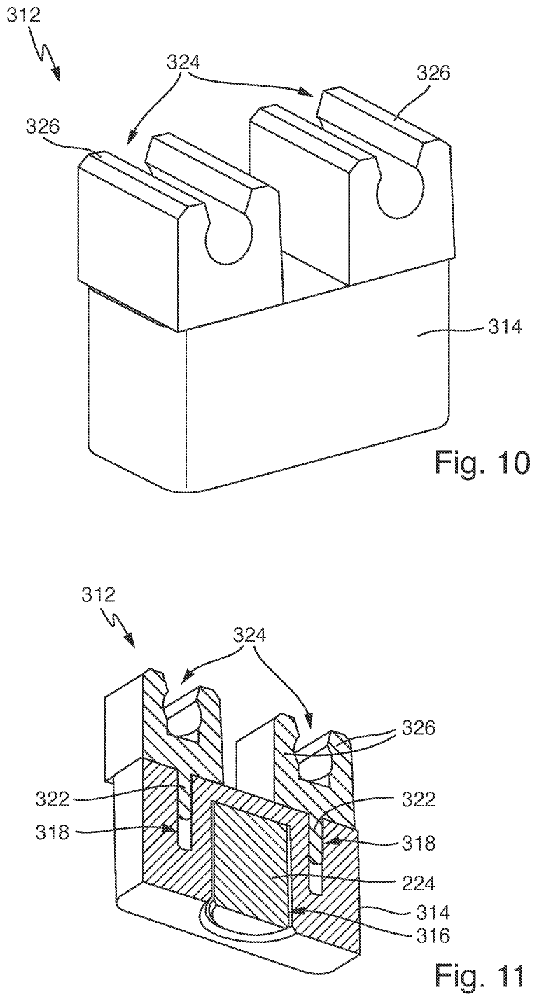

According to FIGS. 1 and 3, tube clamps 312 arranged on the base plate 202 and/or on the plate upper side 220 of the working plate 204 are provided for fastening and routing the tubes (not shown). According to FIGS. 10 and 11, the tube clamp 312 has a clamp base 314 with a hollow-cylindrical clamp magnet receptacle 316 for receiving a cylindrical permanent magnet 224. By means of the permanent magnet 224, the tube clamp 312 can be positioned and fixed as desired on the working plate 204.

The clamp base 314 further has at least one hollow circular-cylindrical clamp receptacle 318 running parallel to the z-axis, wherein a circular-cylindrical clamp shaft 322 of the tube clamp 312 is arranged in and/or screwed into the clamp receptacle 318. The tube clamp 312 further has a tube receptacle 324 which is accessible from above and has two clamp arms 326, wherein a tube can be clamped from above into the tube receptacle 324 and the clamp arms 326 are elastically deformed or bent.

According to FIGS. 2 and 3, the holding device 200 may further have a protective plate 330. In the mounted state, the protective plate 330 extends parallel to the plate plane 222. The protective plate 330 is preferably arranged along the z-axis between the base 236 and the adapter piece 236. The protective plate 330 can preferably be arranged and/or rest on the base upper side 230. Alternatively, the protective plate 330 may be arranged between the adapter piece 236 and the nozzle head 256. The protective plate 330 serves to protect the holding device 200, in particular, from the laser beam of the laser device 600. It can thus be ensured that the holding device 200, in particular, the base plate 202 and/or the working plate 204 and/or the base and/or the tube clamps 312 and/or the tubes and/or the adapter pieces 236 and/or module bars 290, wear less and are durable. It is conceivable that the protective plate 330 is transparent to the human eye and substantially impermeable to the laser beam. For this purpose, the protective plate 330 may be designed such that, by means of dielectric layers or special dyes, selectively light of certain wavelengths, in this case laser light, is absorbed or reflected, or that polarization-dependent materials are used, wherein the laser light has a different polarization than the visible light, or that nonlinear optical materials are used which change their optical properties depending on the light intensity. It should be noted that the protective plate 330 is designed to protect the components of the holding device 200 depending on the laser used (wavelength, power, etc.).

Furthermore, the protective plate 330 may be designed as a grid plate with grid recesses 332. The grid recesses 322 serve to receive the vacuum devices 206 and/or the support modules 208. Preferably, for mounting the holding device 200, first the protective plate 330 with the grid recesses 332 is provided on the working plate 204, wherein the grid recesses 332 are positioned based on the movement path of the laser beam. By means of the grid recesses 332, the vacuum devices 206 and/or the support modules 208 can then be positioned and fixed on the working plate 204. It is thus prevented that a vacuum device 206 is positioned in the movement path of the laser beam after all or that the sheet material 12 is only insufficiently gripped. It is conceivable that the vacuum devices 206 and/or the support modules 208 are at first separated from the bases 226, 288 and are mounted in the order bases 226, 288—protective plate 330—adapter piece 236 or module bar 290. The protective plate 330 can thus additionally be fixed.

According to FIG. 12, the machining device 10 has the laser device 600 in the machining region 18. The laser device 600 is configured such that a laser beam emitted by the laser device 600 and running substantially parallel to the z-axis is directed onto the sheet material 12, and it comes to an energy input into the sheet material 12 at an point of incidence, so that the sheet material can be cut to a cut piece 1 and a waste 2 at the point of incidence. The cut piece 1 is the product to be produced ultimately. The laser beam can preferably be moved over a working region, wherein the working region substantially corresponds to the longitudinal and transverse dimension of the sheet material 12. The laser device 600 preferably has an axis system 602 for moving the laser beam along the x-axis by means of a first linear axis 604 and along the y-axis by means of a second linear axis 606. It is further conceivable for the axis system 602 to have a third linear axis (not shown) for moving along the z-axis.

The sheet material 12, the cut piece 1 and the waste 2 can be handled by means of a transport device 800 according to FIG. 12.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A holding device (200) for holding a sheet material (12) in a machining device (10), in particular a laser machining device, the holding device (200) comprising:
a working plate (204) having a plate upper side (220) extending along a plate plane (222),
vacuum devices (206) extending along a holding direction (271), each having a base (226) arranged on the plate upper side (220) and a nozzle head (256) arranged on the base (226) for suctioning the sheet material (12),
support modules (208) extending along the holding direction (271), each having a module base (288) arranged on the plate upper side (220), and a brush (302) arranged on the module base (288) and extending along a brush plane (301) for supporting the sheet material (12).

2. The holding device (200) according to claim 1, wherein the vacuum devices (206) and/or the support modules (208) are arranged such that the holding direction (271) runs perpendicular to the plate plane (222).

3. The holding device (200) according to claim 1, wherein the working plate (204) comprises a ferromagnetic material, and wherein the vacuum device (206) and/or the support modules (208) each have a permanent magnet (224) for fixing the vacuum device (206) and/or the support modules (208) on the working plate (204).

4. The holding device (200) according to claim 1, wherein the vacuum device (206) has an adapter piece (236) arranged between the base (226) and the nozzle head (256).

5. The holding device (200) according to claim 1, wherein a conduit (272) running along the holding direction (271) is provided in the vacuum device (206), which conduit (272) fluidically connects a conduit input (274) arranged at the base (226) for connecting to a vacuum supply and a conduit output (276) arranged on the nozzle head (256).

6. The holding device (200) according to claim 1, wherein the support modules (208) are arranged on the working plate (204) such that the brush plane (301) runs perpendicular to the plate plane (220).

7. The holding device (200) according to claim 1, wherein the support modules (208) each have a module bar (290) between the module base (288) and the brush (302).

8. The holding device (200) according to claim 1, wherein the support modules (208) each have a brush receptacle (300) for receiving the brush (302).

9. The holding device (200) according to claim 8, wherein a clamping element (308) for fixing the brush (302) in the brush receptacle (300) is provided in the brush receptacle (300).

10. The holding device (200) according to claim 1, wherein a protective plate (330) extending parallel to the plate plane (222) is provided above the working plate (204).

11. The holding device (200) according to claim 10, wherein the protective plate (330) is designed as a grid plate and has grid recesses (332) for receiving vacuum devices (206) and/or support modules (208).

12. The holding device (200) according to claim 1, wherein further at least one tube clamp (312) is provided for fixing tubes.

13. The holding device (200) according to claim 12, wherein the tube clamp (312) has a clamp base (314) having a permanent magnet (224) for fixing the tube clamp (312) on the working plate (204).

14. A modular system comprising at least one working plate (204), having vacuum devices (206) and at least one support module (208), wherein the vacuum devices (206) differ in size and/or in shape and/or in material, wherein the at least one support module (206) has a module base (288) and a brush (302) for supporting a sheet material (12) arranged on the module base (288), which brush (302) extends along a brush plane (301).

15. A machining device (10), in particular a laser machining device, for machining sheet materials (12), said machining device having a support device (200) according to claim 1.
